(19) United States
(12) Patent Application Publication
(10) Pub. No.: US 2007/0146353 A1
(43) Pub. Date: Jun. 28, 2007

(54) Image driving circuit and image display device using same and related driving method

(75) Inventor: Tsung-Ping Liao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/601,919

(22) Filed: Nov. 20, 2006

(30) Foreign Application Priority Data
Nov. 18, 2005 (TW) 94140623

(51) Int. Cl. G09G 5/00

(52) U.S. Cl. 345/204

(57) ABSTRACT

An exemplary image driving circuit (300) includes a differentiating circuit (326), a random access memory (RAM) (322) connected to the differentiating circuit, a decoder (323) connected to the RAM, and a digital/analog (D/A) converter (324) connected to the decoder. The differentiating circuit receives a still image signal or a moving image signal at any one time. The differentiating circuit is further configured for providing the still image signal through the RAM, the decoder, and the D/A converter to a display device, and for providing the moving image signal through the D/A converter to the display device. The RAM is configured for storing the still image signal. The decoder is configured for decoding the still image signal. The digital/analog (D/A) converter is configured for transforming the still image signal to a plurality of driving voltages and transforming the moving image signal to a plurality of driving voltages.

### TECHNICAL FIELD

The present invention relates to an image driving circuit and an image display device using the image driving circuit. The present invention also relates to a method for driving the image display device.

### BACKGROUND

Normally, a mobile phone includes a display panel for displaying information such as the time, phone numbers, or a battery power level of the mobile phone. To decrease the power consumption of the mobile phone, a memory device such as a random access memory (RAM) has been widely used in an image driving circuit of the mobile phone. The memory device is for driving a display panel of the mobile phone when a still picture needs to be displayed.

FIG. 2 schematically shows a typical image display device used in a mobile phone. The image display device 100 includes a display panel 110, and an image driving circuit 120 for driving the display panel 110. The display panel 110 can be a liquid crystal display panel or an organic light emitting diode (OLED) display panel. The image driving circuit 120 is an integrated circuit.

The image driving circuit 120 includes an interface circuit 121, a RAM 122, a decoder 123, a digital to analog (D/A) converter 124, and a buffer 125.

The interface circuit 121 is configured for receiving image signals generated by an external circuit (not shown), and providing the image signals to the RAM 122. Thus still image signals or moving image signals are stored in the RAM 122. The decoder 123 accesses the image signals from the RAM 122, decodes the image signals into a plurality of gradations, and provides the gradations to the D/A converter 124. The D/A converter 124 transforms the gradations into a plurality of driving voltages that represent the image signals, and provides the driving voltages to the buffer 125. Finally, the buffer 125 provides the driving voltages to a display panel 110, and an image corresponding to the image signals are displayed on the display panel 110.

The still image signals and moving image signals are provided according to the different functions of the mobile phone. When the image signals are still image signals, the RAM 122 loads one set of the image signals therein. The RAM 122 retains the set of still image signals until it receives other different set of still image signals. Thus when the image signals are still image signals, operation of the image display device 100 is simple, and the image display device 100 has very low power consumption.

However, when the image signals are moving image signals, the RAM 122 needs to load a set of the image signals therein in each of frames corresponding to the moving image. That is, the RAM 122 needs to load different moving image signals all the time. Thus when the image signals are moving image signals, the operation of the image display device 100 is complicated, and the image display device 100 has high power consumption.

It is desired to provide an image display device having an image driving circuit, and provide a driving method for driving the image display device, all of which overcome the above-described deficiencies.

### SUMMARY

In one preferred embodiment, an image driving circuit includes a differentiating circuit, a RAM connected to the differentiating circuit, a decoder connected to the RAM, and a D/A converter connected to the decoder. The differentiating circuit receives a still image signal or a moving image signal at any one time. The differentiating circuit is further configured for providing the still image signal through the RAM, the decoder, and the D/A converter to a display device, and for providing the moving image signal through the D/A converter to the display device. The RAM is configured for storing the still image signal. The decoder is configured for decoding the still image signal. The D/A converter is configured for transforming the still image signal to a plurality of driving voltages and transforming the moving image signal to a plurality of driving voltages.

Advantages and novel features of the above-described circuit and other embodiments will become more apparent from the following detailed description when taken in conjunction with the accompanying drawings, in which:

### BRIEF DESCRIPTION OF THE DRAWINGS

FIG. 1 is a block diagram of an image display device according to a preferred embodiment of the present invention; and

FIG. 2 is a block diagram of a conventional image display device used in a mobile phone.

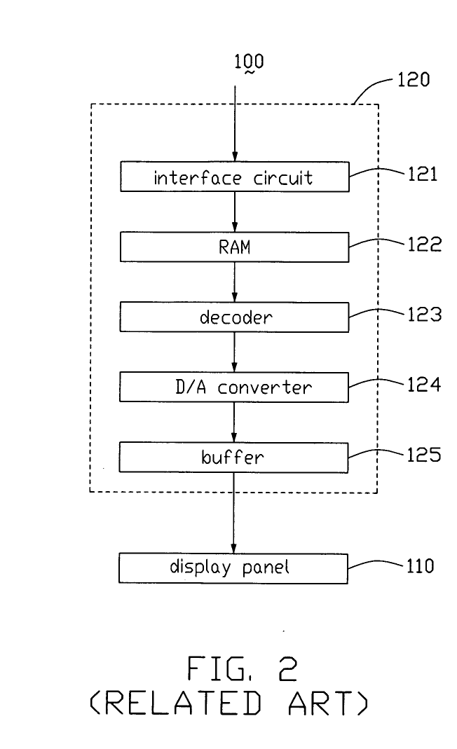

### DETAILED DESCRIPTION OF PREFERRED EMBODIMENTS

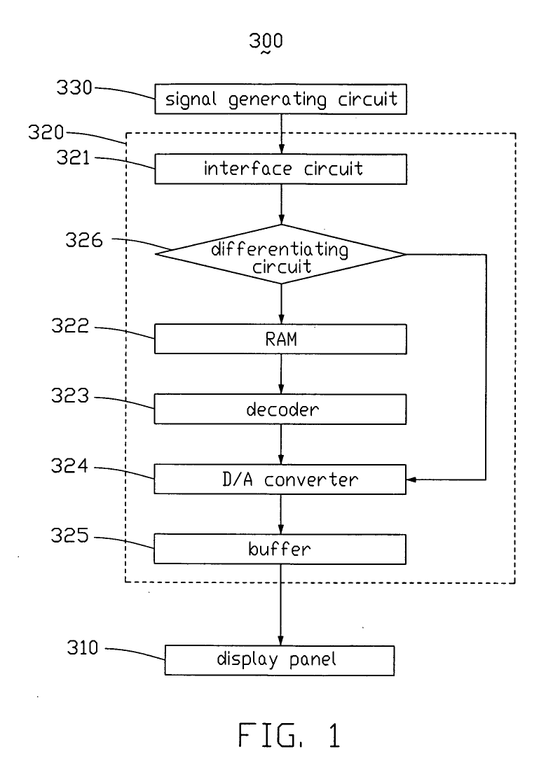

FIG. 1 schematically shows an image display device according to a preferred embodiment of the present invention. The image display device 300 includes a display panel 310, an image driving circuit 320 for driving the display panel 310, and a signal generating circuit 330. The display panel 310 can be a liquid crystal display panel or an OLED display panel. The image driving circuit 320 is characteristically an integrated circuit.

The image driving circuit 320 includes an interface circuit 321, a differentiating circuit 326, a RAM 322, a decoder 323, a D/A converter 324, and a buffer 325.

The signal generating circuit 330 generates a set of still image signals or a set of moving image signals, and provides the still image signals or the moving image signals to the interface circuit 321. Then the interface circuit 321 provides the still image signals or the moving image signals to the differentiating circuit 326. The differentiating circuit 326 performs different actions according to whether the received image signals are still image signals or a moving image signals.

When the differentiating circuit 326 receives still image signals, the differentiating circuit 326 provides the still image signals to the RAM 322. Thus the still image signals are stored in the RAM 322. The decoder 323 accesses the image signals from the RAM 322, decodes the image signals into a plurality of gradations, and provides the gradations to the D/A converter 324. The D/A converter 124 transforms the gradations into a plurality of driving voltages that represent the image signals, and provides the driving voltages to the buffer 325. The buffer 325 provides the driving voltages to the display panel 310.

When the differentiating circuit 326 receives moving image signals, the differentiating circuit 326 directly provides the moving image signals to the D/A converter 324. The D/A converter 324 transforms the moving image signals into a plurality of driving voltages that represent the image signals, and provides the driving voltages to the buffer 325. The buffer 325 provides the driving voltages to the display panel 310.

An exemplary method for driving the image display device 300 includes: receiving an image signal by the interface circuit 321; providing the image signal to the differentiating circuit 326, which is configured for identifying a type of the image signal; when the image signal is a still image signal, transmitting the image signal through the RAM 326, the decoder 323, the D/A converter 324, and the buffer 325 to the display panel 310; and when the image signal is a moving image signal, transmitting the image signal through the D/A converter 324 and the buffer 325 to the display panel 310. In this exemplary method, the RAM 326 is configured for storing the still image signal, the decoder 323 is configured for decoding the still image signal, and the D/A converter 324 is configured for transforming the still image signal into a plurality of driving voltages and transforming the moving image signal into a plurality of driving voltages.

As described above, the image driving circuit 320 includes a differeniating circuit 326 integrated. The differentiating circuit 326 can identify received image signals, and perform different actions according to whether a received image signal is a still image signal or a moving image signal. Therefore there is no need for moving image signals to be stored in the RAM 322. Accordingly, the power consumption of the image display device 300 is reduced.

It is to be understood, however, that even though numerous characteristics and advantages of preferred embodiments have been set out in the foregoing description, together with details of the structures and functions of the embodiments, the disclosure is illustrative only; and that changes may be made in detail, especially in matters of shape, size, and arrangement of parts within the principles of present invention to the full extent indicated by the broad general meaning of the terms in which the appended claims are expressed.

What is claimed is:

1. An image driving circuit comprising:
a differentiating circuit configured for receiving a still image signal or a moving image signal at any one time;
a random access memory (RAM) connected to the differentiating circuit and configured for storing the still image signal;
a decoder connected to the RAM and configured for decoding the still image signal; and
a digital/analog (D/A) converter connected to the decoder and connected to the differentiating circuit and configured for transforming the still image signal to a plurality of driving voltages and transforming the moving image signal to a plurality of driving voltages;
wherein the differentiating circuit is further configured for providing the still image signal through the RAM, the decoder, and the D/A converter to a display device, and for providing the moving image signal through the D/A converter to the display device.

2. The image driving circuit as claimed in claim 1, further comprising a buffer connected to the D/A converter, the buffer being configured to be connected between the D/A converter and the display device.

3. The image driving circuit as claimed in claim 1, further comprising an interface circuit connected to the differentiating circuit and configured for receiving the still image signal or the moving image signal at any one time and providing the still image signal or the moving image signal to the differentiating circuit.

4. The image driving circuit as claimed in claim 1, wherein the image driving circuit is an integrated circuit (IC).

5. An image display device, comprising:
a display panel; and
an image driving circuit configured for driving the display panel, the image driving circuit comprising:
a differentiating circuit configured for receiving a still image signal or a moving image signal at any one time;
a random access memory (RAM) connected to the differentiating circuit and configured for storing the still image signal;
a decoder connected to the RAM and configured for decoding the still image signal; and
a digital/analog (D/A) converter connected to the decoder and connected to the differentiating circuit and configured for transforming the still image signal to a plurality of driving voltages and transforming the moving image signal to a plurality of driving voltages;
wherein the differentiating circuit is further configured for providing the still image signal through the RAM, the decoder, and the D/A converter to the display panel, and for providing the moving image signal through the D/A converter to the display panel.

6. The image display device as claimed in claim 5, further comprising a buffer connected between the D/A converter and the display panel.

7. The image display device as claimed in claim 5, further comprising an interface circuit connected to the differentiating circuit and configured for receiving the still image signal or the moving image signal at any one time and providing the still image signal or the moving image signal to the differentiating circuit.

8. The image display device as claimed in claim 7, further comprising a signal generating circuit connected to the interface circuit and configured for generating the still image signal or the moving image signal at any one time and providing the still image signal or the moving image signal to the interface circuit.

9. The image display device as claimed in claim 5, wherein the display panel is a liquid crystal display panel.

10. The image display device as claimed in claim 5, wherein the display panel is an organic light emitting diode display panel.

11. A driving method for driving a display panel, the method comprising:
receiving an image signal by an interface circuit;
identifying the image signal to be a still image signal or a moving image signal by a differentiating circuit;
providing the image signal through a random access memory (RAM), a decoder, a digital/analog (D/A) converter, and a buffer to the display panel when the image signal is a still image signal; or
providing the image signal through the D/A converter and the buffer to the display panel when the image signal is a moving image signal.
